(19) United States
(12) Patent Application Publication
(10) Pub. No.: US 2025/0209645 A1
(43) Pub. Date: Jun. 26, 2025

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: YUJI YOKOKUBO, Kanagawa (JP)

(21) Appl. No.: 18/978,985

(22) Filed: Dec. 12, 2024

(30) Foreign Application Priority Data
Dec. 22, 2023 (JP) 2023-216513

(51) Int. Cl. G06T 7/33; G06T 7/246; G06T 7/50; G06T 7/73

(52) U.S. Cl. CPC G06T 7/337; G06T 7/248; G06T 7/50; G06T 7/74

(57) ABSTRACT

An information processing apparatus includes at least one processor and at least one memory that is in communication with the at least one processor. The at least one memory stores instructions for causing the at least one processor and the at least one memory to acquire a moving image, acquire a feature point group from an image in a range of a space wider than an imaging range at a position where the moving image is captured, and add, to the moving image, position information about the feature point group associated with the captured position.

### BACKGROUND

### Field of the Disclosure

The present disclosure relates to an information processing apparatus, an information processing method, and a storage medium.

### Description of the Related Art

In recent years, there have been proposed display devices that enable viewers to enjoy stereoscopic images, such as head-mounted displays (HMDs). With a head-mounted display worn on a viewer's head, moving images are arranged and displayed in a space that are aligned with the position and the orientation of the viewer. In such a display device, a process is performed to determine where to arrange and display moving images in a space. International Patent Application Publication No. 2018/131238 discusses a method of determining the arrangement of a video image by adjusting the position and the orientation of the image so that planes or feature points identified on a depth image added to the video image agree with planes or feature points in the environment where the video is to be reproduced.

### SUMMARY

According to an aspect of the present disclosure, an information processing apparatus includes at least one processor and at least one memory that is in communication with the at least one processor. The at least one memory stores instructions for causing the at least one processor and the at least one memory to acquire a moving image, acquire a feature point group from an image in a range of a space wider than an imaging range at a position where the moving image is captured, and add, to the moving image, position information about the feature point group associated with the captured position.

Further features of various embodiments will become apparent from the following description of exemplary embodiments with reference to the attached drawings.

### BRIEF DESCRIPTION OF THE DRAWINGS

FIG. 1 is a diagram illustrating an example of the hardware configuration of an information processing apparatus.

FIG. 2 is a diagram illustrating an example of the functional configuration of the information processing apparatus.

FIG. 3 is a flowchart illustrating a procedure of the information processing apparatus.

FIGS. 4A and 4B are diagrams illustrating an example of displaying video data.

FIG. 5 is a diagram illustrating an example of a three-dimensional feature point group.

FIG. 6 is a flowchart illustrating simultaneous localization and mapping (SLAM) processing.

FIG. 7 is a flowchart illustrating a video data generation process.

FIG. 8 illustrates an example of a data structure of a video file.

FIG. 9 is a table illustrating an example of stored data information.

FIG. 10 is a table illustrating an example of metadata about video data from cameras.

FIGS. 11A and 11B are tables illustrating examples of camera parameters.

FIGS. 12A and 12B are tables illustrating an example of feature point group data.

FIGS. 13A and 13B are tables illustrating an example of object data.

FIGS. 14A and 14B are tables illustrating an example of spatial shape data.

FIGS. 15A and 15B are diagrams illustrating an example of the data structure of the video file.

FIG. 16 is a diagram illustrating an example of the internal structure of the video file.

### DESCRIPTION OF THE EMBODIMENTS

When an insufficient number of feature points are acquired from the video or the depth map due to a large object in the captured video image, for example, that case can make it difficult to determine positions in the video image using the method disclosed in International Publication No. 2018/131238.

The present disclosure is directed to facilitating the determination of the position of an image to be arranged in a space.

An exemplary embodiment will now be described with reference to the accompanying drawings.

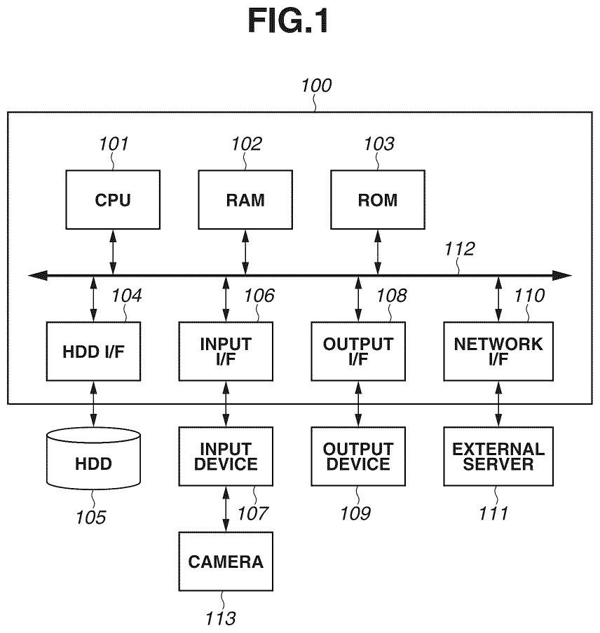

FIG. 1 is a block diagram illustrating the hardware configuration of an information processing apparatus 100 according to the present exemplary embodiment. The information processing apparatus 100 includes a central processing unit (CPU) 101, a random access memory (RAM) 102, and a read-only memory (ROM) 103. Further, the information processing apparatus 100 includes a hard disk drive (HDD) interface (hereinafter, interface will be referred to as “I/F”) 104, an input I/F 106, an output I/F 108, and a network I/F 110. These blocks are connected to each other via a system bus 112.

The CPU 101 generally controls the operation of the information processing apparatus 100. The CPU 101 uses the RAM 102 as a work memory and executes programs stored in the ROM 103 and in a hard disk drive (HDD) 105 to perform processing in flowcharts described below. The HDD I/F 104 connects to a secondary storage device, such as the HDD 105 and an optical disk drive. The HDD I/F 104 is an I/F, such as a serial advanced technology attachment (SATA). The CPU 101 is capable of reading data from the HDD 105 and writing data to the HDD 105 via the HDD I/F 104. The CPU 101 loads data stored in the HDD 105 to the RAM 102, and conversely, saves data loaded to the RAM 102 in the HDD 105.

The input I/F 106 connects to an input device 107, such as a keyboard and a mouse, and a camera 113. The input I/F 106 is a universal serial bus (USB) or Institute of Electrical and Electronics Engineers Standard (IEEE) 1394 or another I/F. The CPU 101 receives input data from the input device 107 via the input I/F 106. Further, the CPU 101 receives video data captured by the camera 113 via the input I/F 106.

The output I/F 108 connects to an output device 109, such as a display. The output I/F 108 is a digital visual interface (DVI), a high-definition multimedia interface (HDMI®), or another video output I/F. The CPU 101 causes the output device 109 to display video data via the output I/F 108. The network I/F 110 is used for performing communications to an external device connected to a network. The CPU 101 transmits and receives data to and from an external server 111 connected to the network via the network I/F 110.

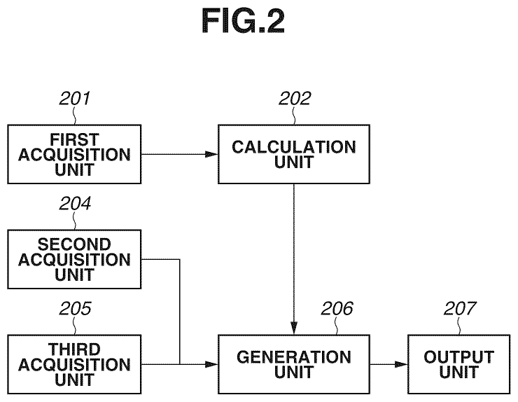

FIG. 2 is a block diagram illustrating the functional configuration of the information processing apparatus 100 according to the present exemplary embodiment. In the information processing apparatus 100, the CPU 101 executes programs stored in the ROM 103 and the HDD 105, and thus the information processing apparatus 100 functions as a first acquisition unit 201, a calculation unit 202, a second acquisition unit 204, a third acquisition unit 205, a generation unit 206, and an output unit 207.

The third acquisition unit 205 acquires video data for viewing. For example, the third acquisition unit 205 acquires, via the input I/F 106, video data captured by a camera attached to a head-mounted display (HMD) while a person wearing the HMD is moving within a space.

The first acquisition unit 201 acquires, via the input I/F 106, video data about the space in which the video data for viewing is captured. The video data acquired by the first acquisition unit 201 is used to acquire information about a feature point group.

In the present exemplary embodiment, an imaging device that captures the video data for viewing (a first video data) and an imaging device that captures the video data used for acquiring the information about the feature point group (a second video data) are different cameras from each other. Thus, imaging devices with different positions, orientations, and angles of view can be used based on the application. The imaging device that captures the first video data and the imaging device that captures the second video data can be the same camera as each other. Further, the imaging device that captures the first video data and the imaging device that captures the second video data can each include a plurality of cameras.

The calculation unit 202 extracts image feature points and amounts of image features at the image feature points from video frames of the video data acquired by the first acquisition unit 201. The calculation unit 202 calculates the position and the orientation of a camera with simultaneous localization and mapping (SLAM) processing based on the extracted information and a three-dimensional feature point map, and updates the three-dimensional feature point map.

The second acquisition unit 204 acquires depth data. The depth data can be acquired by using an active sensing depth camera, such as a time-of-flight (ToF) camera, or can be acquired by using another method, such as stereo matching with a stereo camera. The depth data is an example of depth information.

The generation unit 206 generates video data to which metadata is added based on the pieces of data obtained by the calculation unit 202, the second acquisition unit 204, and the third acquisition unit 205. The video data to which metadata is to be added is used for viewing as an example of a moving image.

The output unit 207 displays the video data provided with metadata on the output device 109, and stores the video data provided with metadata in the HDD 105 as a video file. When the video data with metadata is displayed, a feature point group added to the video data is used to facilitate the determination of the position and the orientation of the video data to be arranged.

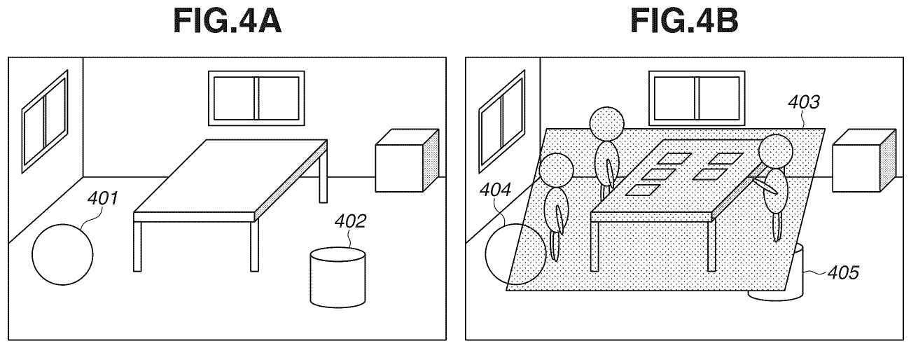

An example of displaying video data at a shooting location will be described with reference to FIGS. 4A and 4B. FIG. 4A illustrates a real space where no video data is displayed. FIG. 4B illustrates a state where video data for viewing is superimposed and displayed in the location illustrated in FIG. 4A. An area 403 is an area on which the video data for viewing is superimposed, and is arranged so that the video data is visible at the same position as when the video data for viewing is captured.

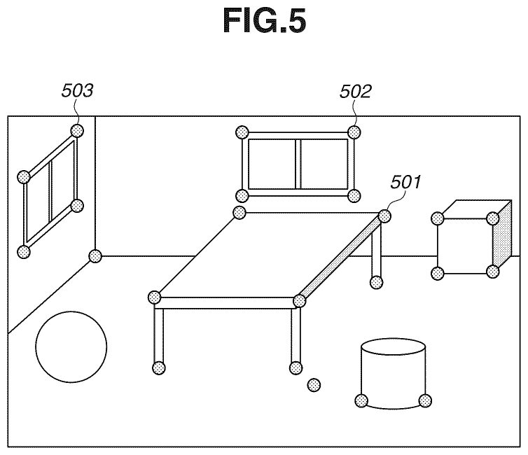

FIG. 5 illustrates a feature point group acquired by SLAM processing on the video data used for acquiring information about the feature point group. The imaging range of the video data used for acquiring information about the feature point group is wider than that of the video data for viewing. Thus, the feature point group illustrated in FIG. 5 includes feature points other than those of the objects in the video data for viewing. In the present exemplary embodiment, feature points outside the area 403, such as a feature point 503, as well as feature points inside the area 403, such as a feature point 501, are added to the video data as metadata. In displaying video data provided with meta data, this facilitates calculation of the location of shooting the video data and determination of the position and the orientation for arranging the video data.

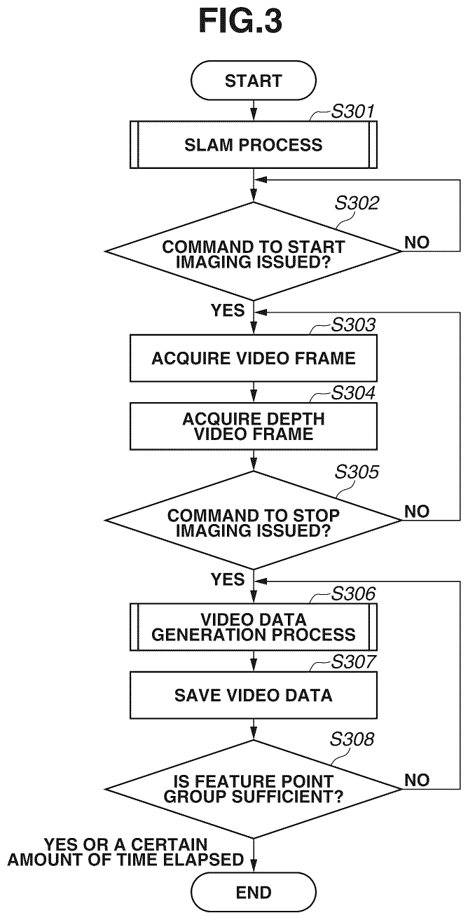

FIG. 3 is a flowchart illustrating a processing executed by the information processing apparatus 100 according to the present exemplary embodiment. Each of the steps (processes) will be represented by adding an S before its reference number. For example, a person wears an HMD including a camera that captures video data for viewing, a camera that acquires a feature point group, and a camera that acquires depth data. The process starts when the CPU 101 acquires video data captured by each of the cameras while the person is moving.

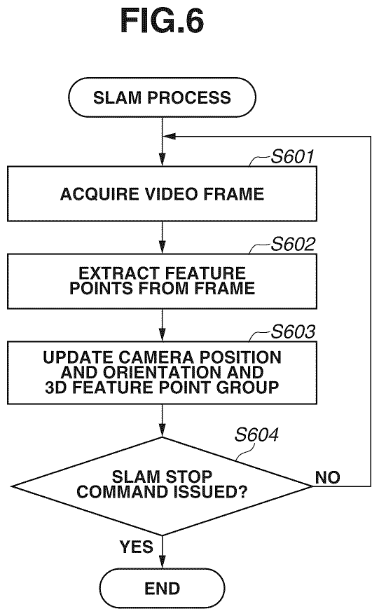

In step S301, the CPU 101 executes SLAM processing based on the video data used for acquiring information about the feature point group. Until receiving a stop command, the CPU 101 continues executing the SLAM processing in a separate thread, sequentially acquires video frames, and sequentially calculates and stores the position and the orientation of the camera and a three-dimensional feature point group. More detail will be described below. The details of this step will be described below with reference to FIG. 6.

In step S302, the CPU 101 waits until a command is issued to start imaging video data for viewing. If the command is issued to start imaging (Yes in step S302), the processing proceeds to step S303.

In step S303, the CPU 101 acquires video frames and internal parameters of the camera from the camera that captures the video data for viewing. The processing proceeds to step S304.

In step S304, the CPU 101 acquires depth frame data corresponding to the video frames acquired in step S303. The depth frame data is acquired by a depth camera. The CPU 101 acquires the depth frame data together with internal parameters of the camera, such as an angle of view of the depth camera. The processing proceeds to step S305.

In step S305, the CPU 101 repeatedly executes the processes of steps S303 and S304 until an imaging stop command is issued to stop capturing the video data for viewing, and sequentially acquires video frames and depth frame data captured while the person is moving. If the imaging stop command is issued (Yes in step S305), the CPU 101 advances the processing to step S306.

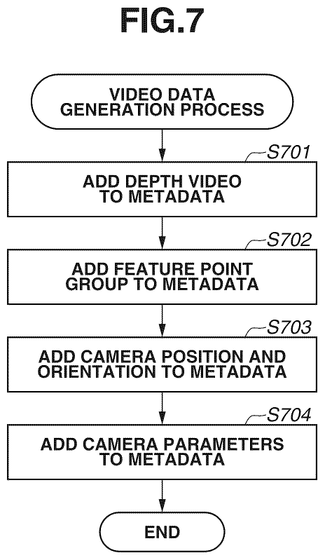

In step S306, the CPU 101 generates video data provided with metadata. The details of this step will be described below with reference to FIG. 7. The processing proceeds to step S307.

In step S307, the CPU 101 records the video data provided with metadata as a video file in an HDD 304. The processing proceeds to step S308.

In step S308, the CPU 101 determines whether the three-dimensional feature point group is sufficient. If the three-dimensional feature point group is sufficient (Yes or a certain amount of time has elapsed in step S308), the processing in the flowchart ends. If the three-dimensional feature point group is insufficient (No in step S308), the processing waits until a certain period of time elapses. While the processing waits until the certain period of time elapses, the SLAM processing continues being executed and the three-dimensional feature point group is updated. If the three-dimensional feature point group is sufficient in the certain period of time, the CPU 101 ends the processing in the flowchart (Yes or a certain amount of time has elapsed in step S308). If the three-dimensional feature point group is insufficient in the certain period of time (No in step S308), the processing proceeds to step S306. Examples of a method of determining whether the three-dimensional feature point group is sufficient includes a method of determining whether the number of feature points is greater than a threshold value. However, the determination method is not limited thereto. A determining method can be employed where, from the position of the camera at a specific frame timing, its vicinity is divided into some sectors by predetermined degree and the three-dimensional features points are detected in a certain percentage of the sectors.

### (SLAM Processing)

FIG. 6 is a flowchart illustrating an example of a procedure in the SLAM processing executed in step S301.

In step S601, the CPU 101 acquires video frames and internal parameters of a camera. To acquire the video frames in the present step, the camera is different from the camera that captures video data for viewing. Specifically, a wide-angle camera is used so that the feature points can be extracted from a range wider than that of the captured video data for viewing. The internal parameters of the camera are information including parameters related to the camera, such as internal parameters indicating characteristics of the camera.

In step S602, the CPU 101 extracts image feature points and amounts of image features from the video frames acquired in step S601. An image feature point is a point that has characteristic information in an image, and is represented using two-dimensional positions. Amounts of image features describe features at image feature points as vectors. Oriented FAST and rotated BRIEF (ORB), scale-invariant feature transform (SIFT), and speeded-up robust features (SURF) can be used to extract image feature points and amounts of image features. The CPU 101 performs object recognition on the video frames, and if an image feature point is detected on an area where an object is detected, the CPU 101 assigns an object identification (ID) to the image feature point. The object ID is used for identifying from which object a feature point is detected. Image feature points detected from the same object are assigned the same object ID. In the object recognition, methods, such as You Only Look Once (YOLO) and Single Shot Multibox Detector (SSD), can be employed.

In step S603, the CPU 101 calculates the position and the orientation of the camera and a three-dimensional feature point group from the information extracted in step S602. In the present exemplary embodiment, Visual SLAM is used to calculate the position and the orientation of the camera and the three-dimensional feature point group. The object ID assigned to the image feature points in step S602 is associated with the three-dimensional feature point group obtained by Visual SLAM. Thus, three-dimensional feature point group data associated with the object ID is generated. Visual SLAM is a well-known technology, and thus, the description thereof will be omitted. Further, shape information about a space from a three-dimensional feature point group can be estimated. For example, the CPU 101 represents a rectangular parallelepiped using parameters of the width, depth, height, and rotation, and acquires the shape of a room by determining the rectangular parallelepiped that agrees with the point group using random sample consensus (RANSAC). When the direction of gravity is known, bearings as rotation around the direction of gravity can be a rotation parameter. In this case, information obtained from a magnetic sensor can be used as the reference for bearings. The room is not limited to a rectangular parallelepiped. For example, a plurality of planes can be estimated from a feature point group and then combined to represent the room.

In step S604, the CPU 101 repeatedly executes the processes of steps S601 to S603 until a command is issued to stop the SLAM processing, and continues to sequentially acquire video frames captured while the person is moving and to calculate positions and orientations of the camera and three-dimensional feature point groups. If the command is issued to stop the SLAM processing (Yes in step S604), the CPU 101 ends the SLAM processing, and the series of processing ends in the flowchart of FIG. 3.

### (Video Data Generation Processing)

FIG. 7 is a flowchart illustrating an example of a procedure of generating video data including metadata according to the present exemplary embodiment.

In step S701, the CPU 101 adds depth data to the video data as metadata. The depth data includes depth frame data and internal parameters of the depth camera.

In step S702, the CPU 101 adds information about the position and the orientation of the camera and the three-dimensional feature point group to the video data as metadata. The information about a three-dimensional feature point group includes three-dimensional position information about the three-dimensional feature points, types of amounts of image features, amounts of image features, and the object ID. The CPU 101 converts the three-dimensional position information about the three-dimensional feature points into a coordinate system in which the direction of gravity is aligned in one axis using the position and the orientation of the camera in the initial frame after the start of imaging as the reference, and stores the converted information. Thus, the CPU 101 associates the position and the orientation of the camera by which the video data is captured with the three-dimensional position information about the three-dimensional feature point group. Through the coordinate system conversion, when the video data provided with metadata is displayed, the video data can be disposed using the origin point of the coordinate system as the camera position to align the video data with the images in the real space.

The CPU 101 can add shape data about the room as metadata.

The CPU 101 can prepare in advance a table in which information about mobilities of objects is set for each of the objects, and add the information about the mobilities of the objects to the object ID. For example, the mobilities of the objects are represented as values from 0 to 1. The walls of a house as an object are unlikely to move, and thus are set to a value of 0.02, while a toy is likely to move, and is set to a value of 0.9. Thus, when video data provided with metadata is displayed, feature points to be used for positioning can be determined based on the mobilities of the objects.

The CPU 101 can store the three-dimensional feature point group in the order based on the distances to an object. The distances to the object can be calculated from a group of points having the same object ID.

The distances to the object can be calculated by using the closest point or the farthest point of the points belonging to the same object ID. The feature points in the three-dimensional feature point group arranged in the order of the distances from the object allows, when the video data is arranged to be aligned with a closer object, some of the feature points to be sequentially read in the order from the closest, and the feature points alone read partly to be used for the alignment.

In step S703, the CPU 101 adds the position and the orientation of the camera to the video data as metadata. Similarly to the three-dimensional feature point group, the CPU 101 converts the position and the orientation of the camera into a coordinate system in which the direction of gravity is aligned in one axis using the position and the orientation of the camera in the initial frame after the start of imaging as the reference, and the CPU 101 stores the converted information. When the camera (the first camera) that captures video data for viewing is different from the camera (the second camera) that captures video data used for acquiring information about a feature point group, data about the position and the orientation of the second camera is converted into data about the position and the orientation of the first camera.

### (Data Structure of Video File)

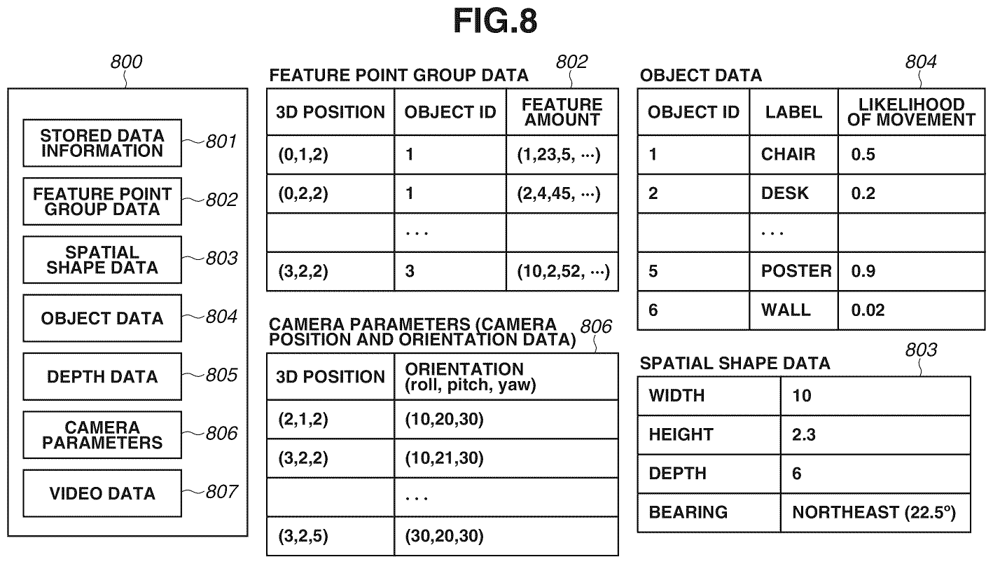

FIG. 8 illustrates an example of a data structure and a specific example of data about a video file according to the present exemplary embodiment. A video file 800 illustrated in FIG. 8 includes stored data information 801, feature point group data 802, spatial shape data 803, object data 804, depth data 805, camera parameters 806, and video data 807.

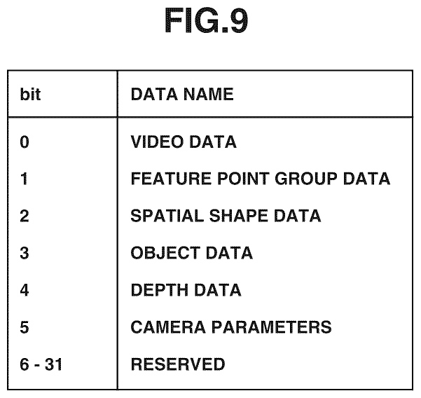

The stored data information 801 indicates what data is stored in the video file 800. FIG. 9 illustrates an example of bit assignments of the stored data information 801. Here, the stored data information 801 has a 32-bit value, and each of the bits indicates that the target data is stored if the value is “1”, and indicates that the target data is not stored if the value is “0”. In the example of FIG. 9, video data is assigned to b0, feature point group data to b1, object data to b3, depth data to b4, and camera parameters to b5. For example, if three types of data, i.e., the video data, the feature point group data, and the camera parameters, are stored in the video file 800 illustrated in FIG. 8, the bits b0, b1, and b5 are “1” and the other bits are “0”.

The feature point group data 802 is information about a three-dimensional feature point group calculated by SLAM processing. The feature point group data 802 holds information about amounts of features and the object ID to which the feature points belong, in association with three-dimensional position information about the feature points.

The spatial shape data 803 is spatial shape data estimated from a three-dimensional feature point group. The spatial shape data 803 holds information indicating the shape of a room, such as the width, height, depth, and orientation.

The object data 804 is information about an object obtained by an object recognition process. The object data 804 holds the object names and information about the mobilities (the likelihood of movement) of the objects, in association with the object ID.

The depth data 805 holds data from the first frame to the N-th frame. N is a natural number grater or equal to 1.

In the camera parameters 806, each of the rows corresponds to information about one video frame, and the camera parameters 806 hold the position of a camera and the orientation of the camera obtained by SLAM processing at the time when the video frame is acquired.

The video data 807 holds data from the first frame to the N-th frame. The video data 807 includes video frames captured by one or more cameras.

Further, metadata is added to each piece of stored data, and the metadata indicates the type of the piece of stored data.

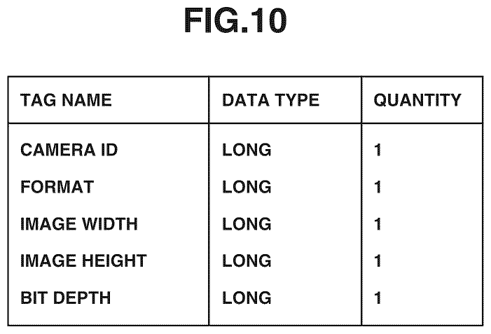

FIG. 10 illustrates an example of metadata about video data from each camera. The metadata about the video data from each camera includes information about a camera ID, a format, an image width, an image height, and a bit depth.

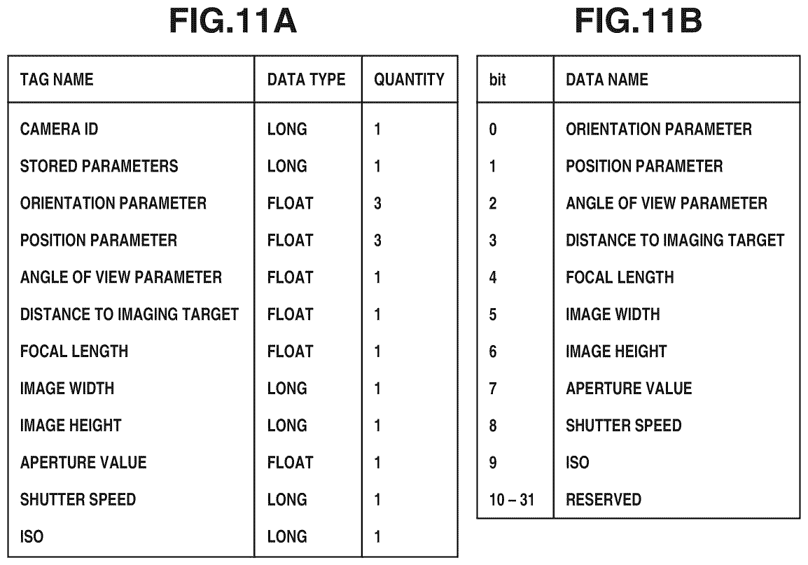

FIG. 11A illustrates an example of metadata in the camera parameters 806. The metadata in the camera parameters 806 includes the camera ID, stored parameters, orientation parameters, position parameters, angle of view parameters, the distance to an imaging target, a focal length, an image width, an image height, an aperture value, a shutter speed, and International Organization for Standardization (ISO) information. FIG. 11B illustrates bit assignments for the camera parameters 806 to be stored. The stored parameters in FIG. 11A have a 32-bit value, and each of the bits indicates that the target data is stored if the value is “1”, and indicates that the target data is not stored if the value is “0”. As illustrated in FIG. 11B, pieces of information in FIG. 11A are each assigned to the corresponding bit of the bits.

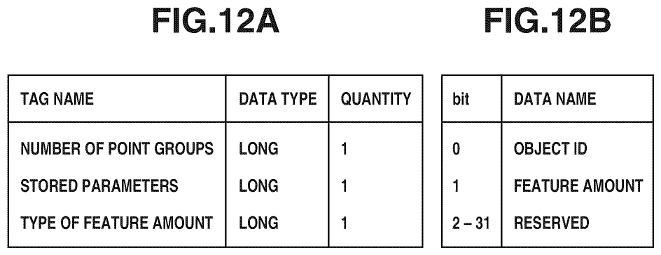

FIG. 12A illustrates an example of metadata about the feature point group data 802. The metadata about the feature point group data 802 includes information about the number of points in the group, stored parameters, and types of amounts of features. FIG. 12B illustrates bit assignments for the feature point group data 802 to be stored. In the example of FIG. 12B, the object ID is assigned to b0, and the amount of the feature is assigned to b1.

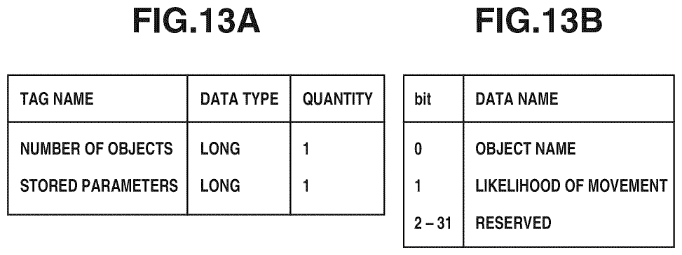

FIG. 13A illustrates an example of metadata about the object data 804. The metadata about the object data 804 includes information about the number of objects and stored parameters. FIG. 13B illustrates bit assignments of the pieces of the object data to be stored. In the example of FIG. 13B, the object name is assigned to b0, and the likelihood of movement is assigned to b1.

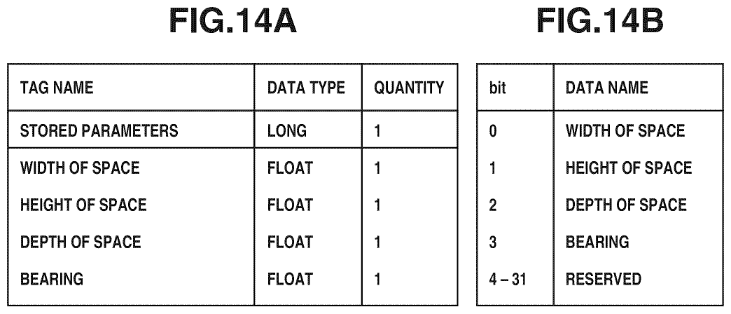

FIG. 14A illustrates an example of metadata about the spatial shape data 803. The metadata about the spatial shape data 803 includes information about stored parameters, the width, the height, the depth of a space, and a bearing. FIG. 14B illustrates bit assignments of the pieces of the spatial shape data 803 to be stored. As illustrated in FIG. 13B, pieces of information in FIG. 14A are each assigned to the corresponding bit of the bits.

As described above, the video data and the metadata are defined and put together in a file format.

One camera parameter 806 can be used for one video file. However, frames can each hold a camera parameter. Frames each holding a camera parameter allow the accommodation of a case where the position and the orientation of the camera change during imaging.

### (Specific Example of Video File)

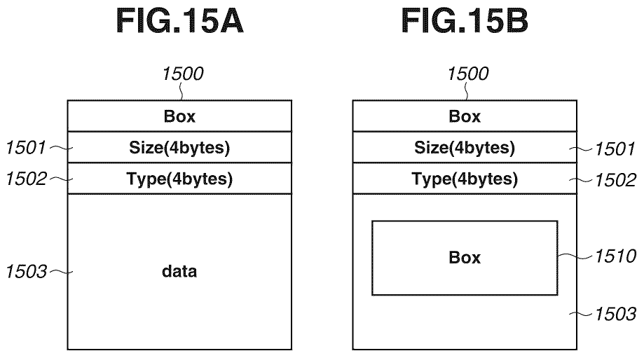

A specific example will be described of a video file according to the present exemplary embodiment that complies with the ISO base media file format (ISO BMFF) ISO/IEC 14496-12 MPEG-4 Part 12 standard. In the ISO BMFF standard, a file is structured in a unit referred to as “a box”. FIG. 15A illustrates the structure of a box. A box 1500 includes an area 1501 that stores size information, an area 1502 that stores type information, and an area 1503 that stores data. As illustrated in FIG. 15B, a structure can be used in which the box 1500 further contains a box 1510 as data.

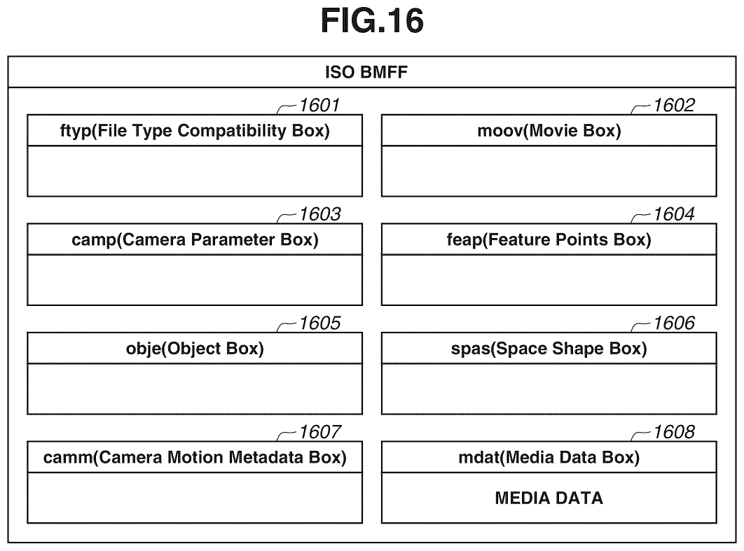

FIG. 16 illustrates an example of the internal structure of a video file that complies with ISO BMFF. A video file complying with ISO BMFF is composed of the boxes of file type compatibility (ftyp) 1601, movie box (moov) 1602, camera parameter data (camp) 1603, feature points box (feap) 1604, object (obje) 1605, space shape (spas) 1606, camera motion metadata (camm) 1607, and media data (mdat) 1608. Each of the boxes will be described in the following.

The file type compatibility box (ftyp box) 1601 is a box arranged as the first box in a file. The ftyp box 1601 stores information about a file format, information indicating a version of the box, information relating to the compatibilities with other file formats, and information about the name of a manufacturer that created the file. The ftyp box 1601 can store the above-described stored data information 801 indicating the type of each piece of data stored in the video file.

The movie box (moov box) 1602 clearly indicates what data is stored in the file and how the data is stored, and stores information, such as a time axis and an address used for managing media data.

The media data box (mdat box) 1608 stores media data, such as a moving image and audio. The depth data 805 and the video data 807 can be stored in the mdat box. Information about how data is stored in the mdat box 1608 stored in the moov box 1602 makes the media data accessible.

The camera motion metadata (camm) box 1607 stores metadata relating to the movement of a camera. The camm box can store the data about the position and the orientation of the camera in the camera parameters 806.

The ftyp box 1601, the moov box 1602, and the mdat box 1608 are boxes common to files compliant with ISO BMFF. The camm box 1607 is, for example, used in the VR180 video format. On the other hand, the boxes the camp 1603, the feap 1604, the obje 1605, and the spas 1606 are specific to video files according to the present exemplary embodiment. The boxes specific to video files according to the present exemplary embodiment will be described below with specific examples.

The camera parameter data box (camp box) 1603 can be set for each piece of video data, and holds information indicating what data is stored as a camera parameter, and the values of the camera parameters corresponding to the pieces of information. One feature points box (feap) 1604 can be set for each video file. The feap 1604 holds information indicating what data is stored as the feature point group data and the values of the feature point group corresponding to the pieces of information. One object box (obje) 1605 can be set for each video file. The obje 1605 holds information indicating what data is stored as the object data and values relating to the object corresponding to the information. The space shape box (spas) 1606 holds information indicating what data is stored as data representing the shape of the captured space, and values relating to the shape corresponding to the information.

In the present exemplary embodiment, the ISO BMFF standard is described as an example. However, the format of a video file is not limited thereto. For example, other standards, such as High Efficiency Image File Format (HEIF) or Multi-Image Application Format (MiAF) that are compatible with ISO BMFF, can be used. Further, the values and expressions of the formats are not limited to those described above. At least one of the boxes the camp 1603, the feap 1604, the obje 1605, and the spas 1606 illustrated in FIG. 16 can be stored in the moov box 1602.

A specific process will be described that is used in aligning positions of images in a real space (for example, FIG. 4A) and video data by using video data including metadata according to the present exemplary embodiment.

First, the CPU 101 acquires an image of the current real space from the camera 113 via the input I/F 106. The CPU 101 acquires the position and the orientation of the camera and the position information about the three-dimensional feature points from the acquired image. Subsequently, the CPU 101 reads all the pieces of feature point group data 802 as metadata. The CPU 101 uses iterative closest point (ICP) to determine the transformation through which the positions of the three-dimensional feature points acquired from the image of the current real space and the positions of the read feature point group data 802 agree with each other, and calculates the origin point of the read feature point group data 802 in the real space. The CPU 101 arranges the video data based on the camera parameters (the position and the orientation of the camera) using the calculated origin point as the reference.

As described above, the information processing apparatus according to the present exemplary embodiment can embed a feature point group obtained from the image of a space larger than the imaging space of the video data to be saved in the video data as metadata. Thus, even if a small number of feature points is obtained from the imaging space of video data, a feature point group in the imaging space that is not imaged in the video data can be used. This facilitates the determination of arrangement positions of video data to be displayed.

### Other Embodiments

In the above-described embodiment, monocular video data provided with depth data is provided. However, video data with parallax can be used instead of monocular video data. Video data with parallax includes two pieces of video data with parallax captured by a parallax imaging device including two lenses. Moreover, monocular video data not including depth data can be used.

In the embodiment described above, in step S308 of FIG. 3, the CPU 101 determines whether the three-dimensional feature point group is sufficient. If the three-dimensional feature point group is insufficient, the processing waits until the three-dimensional feature point group becomes sufficient, and the feature point group data in the metadata is updated. However, the flowchart of FIG. 3 can end without performing the above-described determination.

Some or all of the functions of the blocks and steps in FIGS. 2 and 3 of the above-described embodiment can be performed by hardware, such as an application-specific integrated circuit (ASIC) or an electronic circuit. Further, processing can be performed where programs carrying out some or all of the steps in FIG. 3 are supplied to a system or a device via a network or a storage medium, and one or more processors in a computer of the system or the device read and execute the programs.

According to the present disclosure, the determination of the position of an image to be arranged in a space can be facilitated.

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2023-216513, which was filed on Dec. 22, 2023 and which is hereby incorporated by reference herein in its entirety.

What is claimed is:

1. An information processing apparatus comprising:
at least one processor; and
at least one memory that is in communication with the at least one processor,
wherein the at least one memory stores instructions for causing the at least one processor and the at least one memory to:
acquire a moving image;
acquire a feature point group from an image in a range of a space wider than an imaging range at a position where the moving image is captured; and
add, to the moving image, position information about the feature point group associated with the captured position.

2. The information processing apparatus according to claim 1, wherein the position information about the feature point group is converted so that a position and an orientation of an imaging device by which the moving image is captured is used as a reference.

3. The information processing apparatus according to claim 1, wherein an imaging device configured to capture the moving image is different from an imaging device configured to capture an image used to acquire the feature point group.

4. The information processing apparatus according to claim 1, wherein the at least one memory further stores instructions for causing the at least one processor and the at least one memory to:
acquire object information from the image used to acquire the feature point group; and
associate the object information with each feature point of the feature point group.

5. The information processing apparatus according to claim 4, wherein the at least one memory further stores instructions for causing the at least one processor and the at least one memory to:
acquire a distance from the imaging device to the object by using the moving image; and,
when adding the position information about the feature point group, use an order based on a distance to the object associated with each feature point of the feature point group.

6. The information processing apparatus according to claim 4, wherein the object information includes information relating to a likelihood of movement.

7. The information processing apparatus according to claim 1, wherein the at least one memory further stores instructions for causing the at least one processor and the at least one memory to:
acquire information about a shape of an imaging space from the image used to acquire the feature point group; and
add the information about the shape of the imaging space to the moving image.

8. The information processing apparatus according to claim 7, wherein the information about the shape of the imaging space includes information about a width, a height, and a depth.

9. The information processing apparatus according to claim 7, wherein the information about the shape of the imaging space includes information about a bearing.

10. The information processing apparatus according to claim 1, wherein the at least one memory further stores instructions for causing the at least one processor and the at least one memory to:
acquire depth information about the moving image, and
add the depth information to the moving image.

11. The information processing apparatus according to claim 1, wherein the at least one memory further stores instructions for causing the at least one processor and the at least one memory to acquire the position information about the feature point group by performing simultaneous localization and mapping (SLAM) processing.

12. The information processing apparatus according to claim 1, wherein the at least one memory further stores instructions for causing the at least one processor and the at least one memory to:
acquire an image of a real space;
acquire a position and an orientation of a camera and position information about a feature point group from the image of the real space; and
control to align the image of the real space with the moving image based on the position information about the feature point group, the position and the orientation of the camera, and the position information about the feature point group.

13. The information processing apparatus according to claim 1, wherein the at least one memory further stores instructions for causing the at least one processor and the at least one memory to add, to the moving image, a position and an orientation of an imaging device by which the moving image is captured.

14. The information processing apparatus according to claim 1, wherein the moving image to which the position information about the feature point group is added is saved as a moving image file.

15. An information processing method comprising:
acquiring a moving image;
acquiring a feature point group from an image in a range of a space wider than an imaging range at a position where the moving image is captured; and
adding, to the moving image, position information about the feature point group associated with the captured position.

16. A non-transitory computer-readable storage medium storing instructions that, when executed by a computer, cause the computer to perform a method comprising:
acquiring a moving image;
acquiring a feature point group from an image in a range of a space wider than an imaging range at a position where the moving image is captured; and
adding, to the moving image, position information about the feature point group associated with the captured position.
